(19) United States
(12) Patent Application Publication
(10) Pub. No.: US 2005/0253295 A1
(43) Pub. Date: Nov. 17, 2005

(54) Method of manufacturing biodegradable packaging material and apparatus therefor

(76) Inventors: Jin-Hua Song, Uxbridge (GB); Yong Gang Kang, Uxbridge (GB); Karnik Tarverdi, Uxbridge (GB); Bruce Yeo, London (GB)

Correspondence Address: DINESH AGARWAL, P.C., 5350 SHAWNEE ROAD, SUITE 330, ALEXANDRIA, VA, 22312, US

(21) Appl. No.: 11/117,644

(22) Filed: Apr. 29, 2005

(30) Foreign Application Priority Data
Apr. 30, 2004 (GB) GB 0409714.3

(51) Int. Cl. B29C 47/00

(52) U.S. Cl. 264/177.11; 425/392

(57) ABSTRACT

An apparatus and a method for making a biodegradable material are disclosed. The apparatus comprises an extruder for forming a foamed starch rod and a heated die for modifying the rod. The rod is fed through the heated die by feeding rollers. A bonding agent application station is located downstream of the heated die and upstream of a packing unit. The method comprises forming a foamed starch rod by extrusion and passing the rod through a heated die. The rods may be formed into sheets or blocks by cutting, the application of bonding agent and adhering the cut rods together.

### TECHNICAL FIELD

The invention relates to a method of manufacturing a biodegradable packaging material from foamed starch rods, and to apparatus therefor.

### BACKGROUND

The manufacture of a biodegradable packaging material comprising an ordered structure of lengths of foamed starch rod is disclosed in GB-A-2 352 230. This document discloses the adhesion bonding of lengths of foamed starch rods formed by high temperature short time (HTST) extrusion cooking to produce blocks or planks. Water or another adhesive is applied to the surface of each length of rod before the lengths are arranged into an ordered structure. When the adhesive is water reinforcement ribs of denser material are formed along the regions of contact between adjacent lengths of rod. The properties of the planks or blocks formed depend on the extent, spatial distribution, and thickness of the reinforcement ribs.

### SUMMARY OF THE INVENTION

It has now been found that by subjecting lengths of extruded foamed starch rod to a thermal forming process prior to adhesion bonding it is possible to modify their surface finish, dimensional stability and cross sectional geometry.

According to a first aspect of the present invention there is provided a method for making a biodegradable material for packaging comprising:
(a) providing an extruded foamed starch rod; and
(b) passing the rod through a heated die.

A foamed starch rod comprises starch and, optionally, additives such as plasticisers, for example poly vinyl alcohol, or nucleating agents, for example talc or bran. The methods of the invention may include extruding a foamed starch rod.

The starch may be unmodified starch. A currently preferred starch source for the preparation of foamed starch rods is wheat flour containing around 9% protein.

Preferably, the rod is bonded to at least one other such rod.

Preferably, a bonding agent is applied to at least one surface of the rod.

Preferably, the bonding agent is a liquid, more preferably water.

Preferably, the bonding agent is applied using a jet spray system, a porous media using capillary suction, an ink jet printing system or one or more rollers.

Preferably, the die is heated to a temperature of between 80° C. and 350° C. The temperature employed in any given case will depend upon the rate at which the rods are passed through the die. If the rods are passed through the die at high speed, a high temperature will be required; however, if the rods are passed through the die at low speed a lower temperature may be employed.

Preferably, the rods are passed through the heated die at a speed of 10 ms⁻¹ or less, more preferably 6 ms⁻¹. For a given die temperature, to increase the rate at which rods may be passed through the die the length of the die may be extended to increase the contact time between the rods and the die.

According to a second aspect of the present invention there is provided apparatus for making a biodegradable material for packaging comprising: an extruder for forming a foamed starch rod; a heated die for modifying the rod; and means for feeding the rod through the die.

Preferably, the apparatus comprises means for bonding the rod to another such rod.

Preferably, the apparatus comprises an applicator for applying a bonding agent to at least one surface of the rod.

Preferably, the applicator is a jet spray system, a porous media using capillary suction, an ink jet printing system or one or more rollers.

The rods may be bonded to one another to form a flat array of rods which may be hot rolled into patterned panels or sheets and/or stacked with one or more other flat arrays to form multi-layer blocks.

Preferably, the principal axes of the lengths of rod of a flat array are generally in axial alignment.

In multi-layer blocks, the principal axes of the lengths of rod of one layer may not be in axial alignment with the principal axes of the lengths of rod of an adjacent layer or layers. The principal axes of the lengths of rod of each layer may be generally transverse to those of the adjacent layer or layers.

### BRIEF DESCRIPTION OF THE DRAWINGS

The invention will now be described in more detail, by way of example only, with reference to the accompanying drawings, in which:

FIG. 1 is a diagrammatic plan view of apparatus for making a biodegradable packaging material according to the invention; and

FIG. 2 is a diagrammatic cross-section along the line II-II of FIG. 1.

### DETAILED DESCRIPTION OF THE INVENTION

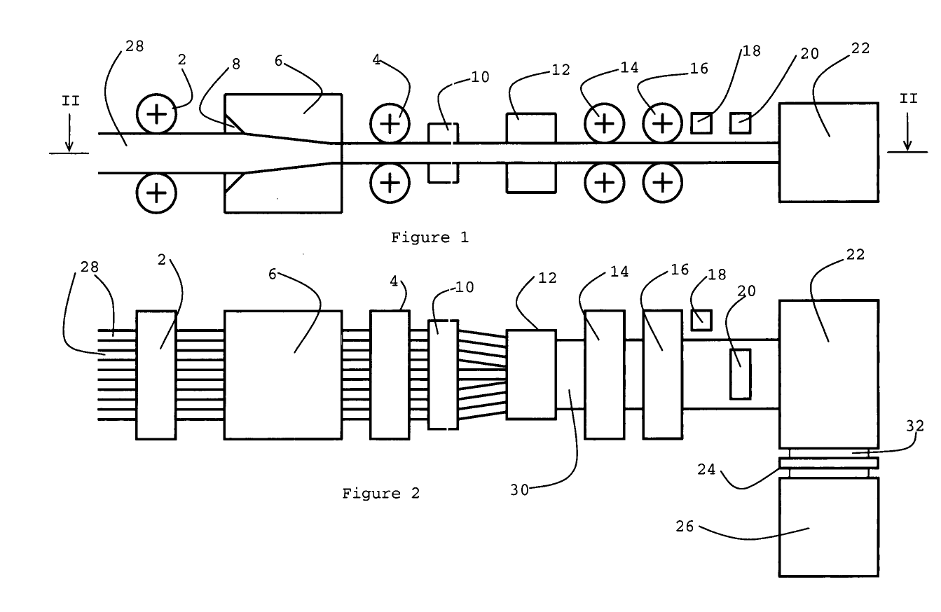

The apparatus shown diagrammatically in FIGS. 1 and 2 comprises a first pair 2 of powered feeding rollers and a second pair 4 of powered feeding rollers disposed either side of a die 6 having a plurality of channels 8. A first bonding agent application system 10 is disposed downstream of the second pair 4 of feeding rollers, and upstream of a packing unit 12 and a third pair of powered feeding rollers 14. A pair of powered, heated patterning rollers 16 are optionally mounted downstream of the third pair 14 of powered feeding rollers.

For the production of multi-layer blocks, a second bonding agent application system 18 is disposed adjacent to a cutter 20, downstream of the third pair 14 of powered feeding rollers and, if present, the pair of powered patterning rollers 16. A joining unit 22, third bonding agent application system 24 and a stacking unit 26 are mounted downstream of the cutter 20.

In use, a plurality of continuous foamed starch rods 28 formed by conventional HTST extrusion are guided by the first 2 and second 4 pairs of powered feeding rollers at a speed of up to 10 ms⁻¹ through the die 6, which is heated to a temperature of between 80° C. and 350° C. The rods 28 are then pulled by the third pair 14 of powered feeding rollers past the first bonding agent application system 10 and the packing unit 12. As the rods 28 pass through the first bonding agent application system 10, a bonding agent is applied to their surfaces. The rods 28 are drawn through a channel in the packing unit 12 the width of which tapers in the direction of movement of the rods. As the rods pass through the channel they are compressed together so that they bond to one another to form a flat array 30 of rods. When included, the powered, patterning rollers 16 are heated to a temperature of between 80° C. and 350° C., depending upon the rate at which the rods are fed past the rollers, and hot roll or pattern the array 30.

To form multi-layer blocks, the array 30 is pulled by the third pair 14 of powered feeding rollers past the second bonding agent application system 18 and the cutter 20 to the joining unit 22. As the array 30 passes the second bonding agent application system 18, a second bonding agent is applied to the sides of it. The array 30 is then cut to a desired length by the cutter 20 and forwarded to the joining unit 22 where it is bonded to one or more like arrays to form a plank 32 of desired width. A travelling mechanism is used to ensure that the cutter 20 travels along at the same speed as the array 26 and cuts across the array 30 to form a cut edge which is perpendicular to the direction of the rods 28 making up the array 30. The plank 32 having the desired length and width is then pulled past the third bonding agent application system 24 to the stacking unit 26 where it is stacked with one or more like planks to form a multi-layer block. As the plank passes the third bonding agent application system 24, a third bonding agent is applied to the top surface of the plank 32. The stacking unit 26 applies pressure to the top surface of the plank and allows for the horizontal rotation of the plank so that the orientation of the rods 28 making up the planks 32 which form the multi-layer block can be varied relative to one another.

The first 2, second 4 and third 14 pairs of feeding rollers and the optional pair of patterning rollers 16 are powered so that their rotation speeds may be adjusted and synchronised. The rollers are also made in halves so that they may be removed and replaced without disassembling the shafts and the machine framework, thereby allowing the nip between each pair of rollers to be easily adjusted. The surface of each of the three pairs of feeding rollers is coated with material such as rubber for effective gripping of the foam.

The pair of powered heated patterning rollers 16 may be used to shape the plank 26 and/or to apply a pattern, such as a manufacturer's logo or description of the goods to be packaged, to its surface.

The die 4 is insulated to reduce heat loss and the entrances of the channels 8 are funnel-shaped to avoid blockage of the entrances by the foamed starch. Preferably, the die channels are formed by inserts which may be removed and replaced without disassembling the machine framework.

The bonding agent applied by the first, second and third bonding agent application systems may be solid or liquid and may be the same or different. Liquid bonding agents are preferred for ease of handling and control. If the bonding agents are liquid, they may be aqueous or non-aqueous; the preferred bonding agent is water. The quantity of bonding agent applied to a given area is controlled by a regulating mechanism in each of the adhesion application systems. Known application apparatus may be employed to apply the bonding agents to the surface of the rods. Preferably, to ensure uniform and accurate distribution of the bonding agents, the bonding agent application systems are jet spray systems, porous media using capillary suction or ink jet printing systems. Where a jet spray system is used it is regulated by air pressure and pressure in the bonding agent. Where a porous medium is used it is regulated by the selection of the medium type, its thickness and contact area with the rods. Where an ink jet printing system is used it is regulated by the printing pattern and voltage on the firing signals.

While in the foregoing example the foamed starch rods are bonded to one another through application of a bonding agent to the surface of the rods, it will be appreciated that rods produced by the apparatus and method of the present invention need not be bonded to one another or could be bonded to one another in other ways, for example using tape.

From the foregoing example it will be appreciated that methods according to the invention can be used to modify the foam density of the starch rods to increase their resiliency to static loading and impact.

Furthermore, it will also be appreciated that the invention enables rods having desired dimensions and shape to be produced which have improved surface finish over rods formed using known extrusion foaming processes, thereby facilitating the application of bonding agent to the rods and the subsequent arrangement of the rods into an ordered structure.

1. A method for making a biodegradable material for packaging comprising:
(a) providing an extruded foamed starch rod; and
(b) passing the rod through a heated die.

2. The method of claim 1 wherein the cross-section of the rod is altered in step b).

3. The method of claim 1 or 2 wherein the shape of the cross-section of the rod is altered in step b).

4. The method of claim 1 wherein 1 or 2 in which the surface of the rod is altered in step b).

5. The method of claim 1 or 2 wherein to any preceding claim comprising:
(a) providing a plurality of extruded foamed starch rods; and
(b) passing the rods through a heated die.

6. The method of claim 1 or 2 further comprising bonding a rod which has passed through the heated die to at least one other such rod.

7. The method of claim 6 further comprising applying an bonding agent to at least one surface of the said rod.

8. The method of claim 1 wherein 7 wherein the bonding agent is a liquid.

9. The method of claim 1 wherein 7 or 8 wherein the bonding agent is water.

10. The method of claim 1 wherein 7 or 8 wherein the bonding agent is applied using a jet spray system, a porous media using capillary suction, an ink jet printing system or one or more rollers.

11. The method of claim 6 wherein the rods are bonded to one another to form a flat array.

12. The method of claim 11 further comprising shaping and/or applying a pattern to the surface of the array.

13. The method of claim 12 wherein the array is shaped and/or the pattern is applied using a heated roller.

14. The method of claim 1 or 2 wherein the die is heated to a temperature of between 80° C. and 350° C.

15. The method of claim 1 or 2 wherein the rods are passed through the die at a speed of 10 ms⁻¹ or less.

16. The method of claim 1 or 2 wherein the rods are passed through the die at a speed of 6 ms⁻¹ or less.

17. Apparatus for making a biodegradable material for packaging comprising:
an extruder for forming a foamed starch rod;
a heated die for modifying the rod; and
means for feeding the rod through the die.

18. The apparatus of claim 17 comprising:
at least one extruder for forming a plurality of foamed starch rods;
a heated die for modifying the rods; and
means for feeding the plurality of rods through the die.

19. The apparatus of claim 17 or 18 further comprising means downstream of the die for bonding a rod to another rod.

20. The apparatus of claim 17 or 18 further comprising an applicator for applying a bonding agent to at least one surface of said rod.

21. The apparatus of claim 20 wherein the applicator is a jet spray system, a porous media using capillary suction, an ink jet printing system or one or more rollers.

22. The apparatus of claim 19 further comprising a stacking unit for laminating layers of bonded rods to one another to form a multi-layer product.
